(19) United States
(12) Patent Application Publication
(10) Pub. No.: US 2021/0304258 A1
(43) Pub. Date: Sep. 30, 2021

(54) SYSTEM FOR COMPLIANT COMMUNICATIONS FOR REAL ESTATE INVESTORS

(71) Applicant: Jason Nickel, Golden, CO (US)

(72) Inventor: Jason Nickel, Golden, CO (US)

(21) Appl. No.: 17/345,386

(22) Filed: Jun. 11, 2021

Related U.S. Application Data
(63) Continuation-in-part of application No. 16/801,773, filed on Feb. 26, 2020, now abandoned.

(51) Int. Cl. G06Q 30/02; G06Q 50/16

(52) U.S. Cl. CPC G06Q 30/0269; G06Q 30/0204; G06Q 50/16

(57) ABSTRACT

A real estate investment management system is disclosed, comprising a real estate database to store real estate data and transmit the real estate data to a real estate investment system via a real estate server. The Skip Trace system permits the system to scan through a database of properties and property owner information which is transmitted to a litigator database which stores litigator data and transmits the litigator data to the real estate investment system via a litigator server. A comparator compares the real estate data with the litigator data to determine if one or more potential litigators are present in a subset of the real estate data. A parsing engine removes the one or more potential litigators from the subset of the real estate data and a communications module is operable to manually transmit compliant communications from the real estate investment system to a real estate owner.

### CROSS-REFERENCE TO RELATED APPLICATIONS

This application is a continuation-in-part and claims the benefit of U.S. Non-provisional application Ser. No. 16/801,773 filed Feb. 26, 2020.

### TECHNICAL FIELD

The embodiments generally relate to management systems and more specifically relate to system for managing real estate investment leads in a network environment.

### BACKGROUND

Sales and lead generation often works on a sales funnel concept wherein leads are generated, processed, and finalized. Each step may be performed by a person or by various computerized systems configured to automate and optimize the sales process.

Real estate investors utilize various forms of sales funnels to facilitate the purchase of a property, which they hope to turn into a profit. Generating an efficient sales funnel can prove difficult due to the diversity of properties that are available for sale and the inefficient means for procuring leads for potential sales. Locating properties with which to invest requires searching through market listings, real estate databases, foreclosure databases, and other means by which properties are listed. Contacting property owners directly requires adherence to various regulations. Marketing strategies available to many industries are either not applicable or are restricted for real estate markets, resulting in missed opportunities for real estate investors.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein disclose a real estate investment management system, comprising a real estate database to store real estate data and transmit the real estate data to a real estate investment system via a real estate server. A litigator database stores litigator data and transmits the litigator data to the real estate investment system via a litigator server. A comparator compares the real estate data with the litigator data to determine if one or more potential litigators are present in a subset of the real estate data. A parsing engine removes the one or more potential litigators from the subset of the real estate data, and a communications module constructed and arranged to facilitate the transmission of communications between a real estate investment system and a real estate owner's device. The system may systematically facilitate the processing and separation of favorable data from non-favorable data according to multiple predetermined variable parameters and by systematically comparing said multiple predetermined variable parameters to the real estate data and the litigator data to systematically process and separate high potential sales leads from low potential sales leads for the acquisition of property from potential sellers.

The system will allow for real estate investors (herein referred to as “user(s)”) to communicate with property owners to solicit the potential sale of the property. The user indicates one or more locations to transmit communications to property owners who own property at a price point, build date, property type, or other parameter commonly associated in the art of real estate.

The system allows for systematic separation of low quality leads and potential litigators from a list of prospects provided by the system or the user. This allows for communications to be transmitted to property owners who are less likely to litigate, and who may be more likely to sell a property they own. Further, the system provides a communication campaign to contact property owners who match user-defined parameters. The system is configured to be compliant with current regulations by providing a means for human intervention during the messaging process. In such, human intervention may or may not initiate every instance of communication between the system and the property owner.

In one aspect, an analytics engine systematically analyzes communications transmitted between the real estate investment system and the real estate owner to optimize a campaign, wherein a communication module, real estate investment system, and real estate owner's device are in operable communication with one another via the network.

In one aspect, the analytics engine transmits analytical data to a user dashboard interface to display the analytical data on a display of a computing device.

In one aspect, a messaging interface provides a plurality of templates to the user such that the user may select from the plurality of templates and apply the selected template to a campaign.

In one aspect, the analytics engine monitors the success rate of each of the plurality of templates.

In one aspect, the plurality of templates are stored in a messaging database in operable communication with the real estate investment system via a messaging server.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a screenshot of the user dashboard interface, according to some embodiments;

FIG. 2 illustrates a screenshot of the Skip Trace interface, according to some embodiments;

FIG. 3 illustrates a screenshot of the messaging interface, according to some embodiments;

FIG. 4 illustrates a screenshot of the communications interface, according to some embodiments;

FIG. 5 illustrates a screenshot of the prospects and messages interface, according to some embodiments;

FIG. 6 illustrates a block diagram of the real estate investment system, according to some embodiments;

FIG. 7 illustrates a block diagram of the lead generation system, according to some embodiments;

FIG. 8 illustrates a block diagram of the lead management system, according to some embodiments;

FIG. 9 illustrates a flowchart of a process for real estate investment lead generation, according to some embodiments; and

FIG. 10 illustrates a block diagram of the network infrastructure, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein provide a system for managing real estate leads by soliciting potential sellers having user-specified parameters. The system will allow for real estate investors (herein referred to as “user(s)”) to communicate with property owners to solicit the potential sale of the property. The user indicates one or more locations to transmit communications to property owners who own property at a price point, build date, property type, or other parameter commonly associated in the art of real estate.

The system allows for separation of low quality leads and potential litigators from a list of prospects provided by the system or user. This allows for communications to be transmitted to property owners who are less likely to litigate, and who may be more likely to sell a property they own. The system may be constructed and arranged to facilitate the transmission of communications between a real estate investment system and a real estate owner's device wherein a communication module, real estate investment system, and real estate owner's device are in operable communication with one another via the network. Further, the system provides a manual communication method to contact property owners who match user-defined parameters. The system is configured to be compliant with current regulations by providing a means for human intervention during the campaign process. In such, a person is tasked with intervening in the communication stream between the system and the property owner.

As used herein, the terms “user” or “users” may refer to a real estate investor, real estate investment group, or other person or group engaging in real estate data and specifically those utilizing real estate data for the generation of leads for the potential sale of real estate. User(s) may also refer to administrative users acting in an administrative capacity within the system.

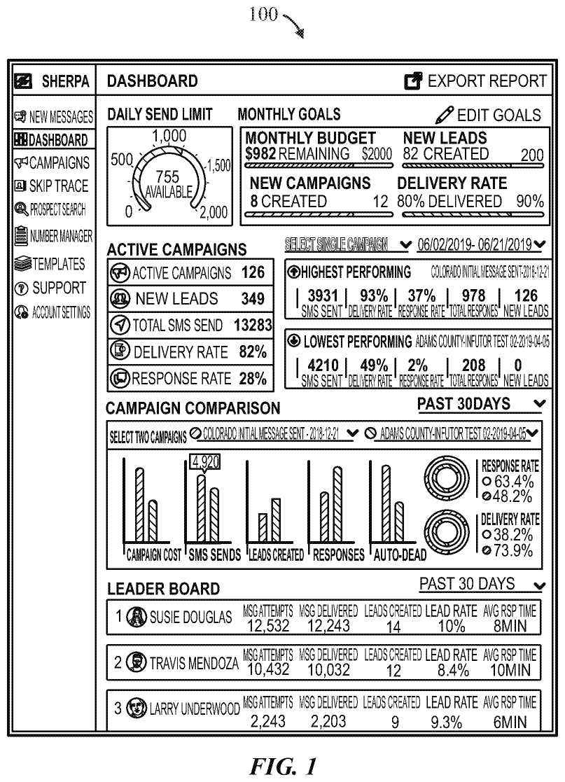

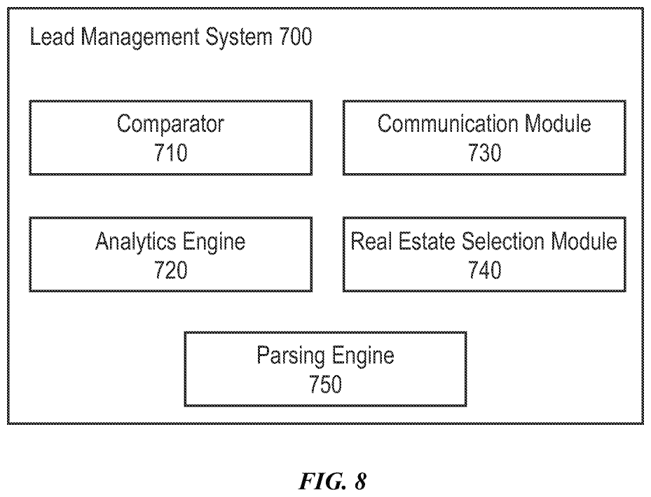

FIG. 1 illustrates a screenshot of the user dashboard interface 100 provided on the display of a computing device. The dashboard 100 comprises a plurality of data portions including a daily sending limit portion, monthly goals portion, active campaigns portion, campaign comparison portion, and leader board portion. An analytics engine (as shown in FIG. 8) receives and analyzes data which may aid the user in optimizing efforts to convert leads into purchases of a property. Analytics may then be provided on the dashboard. For example, the analytics engine may analyze a plurality of campaigns to determine favorable techniques for communicating with property owners in a particular area, at a particular estimated property value, or other real estate parameter.

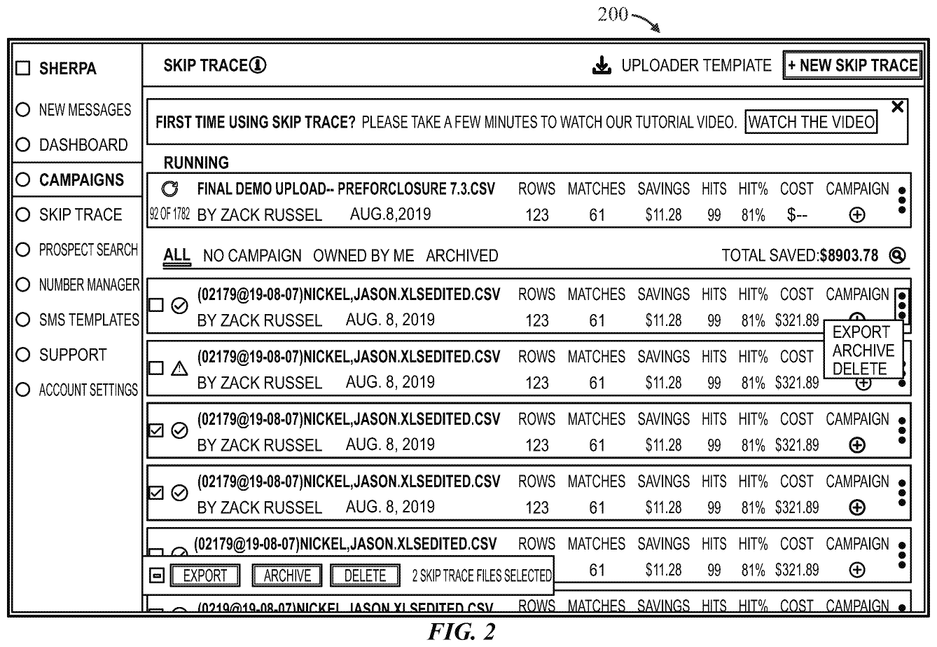

FIG. 2 illustrates the Skip Trace interface 200 configured to permit the user to enrich data related to one or more campaigns. For example, a Skip Trace result may feature data metrics (such as rows, matches, savings, hits, hit %, and cost) for each file imported from an external real estate database. The Skip Trace interface permits users to upload data to the system, enrich the data with prospect contact information such as phone numbers and emails, and begin the process of contacting prospects by then pushing enriched data to a campaign.

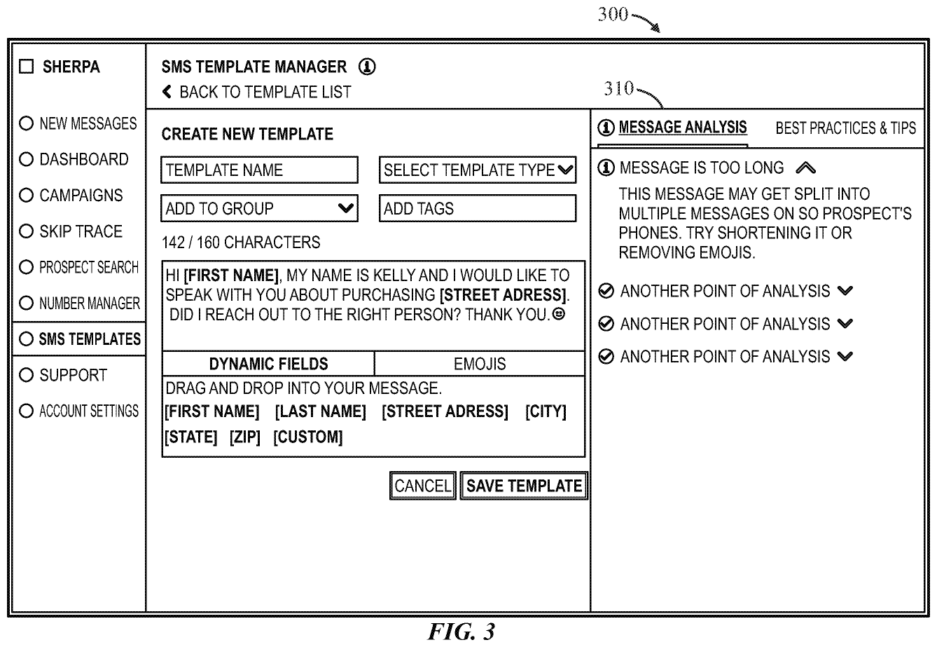

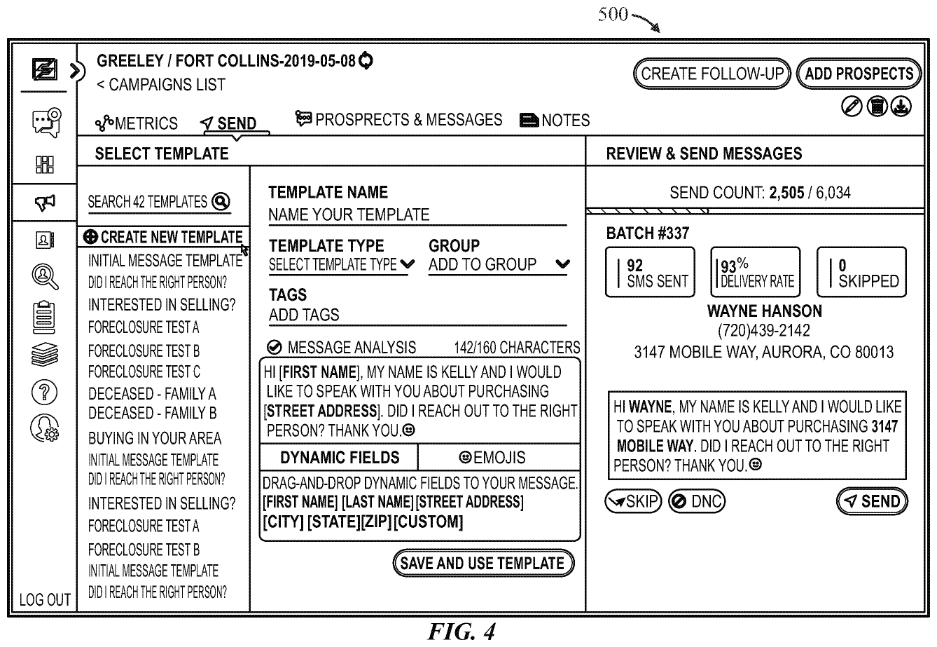

FIG. 3 illustrates a messaging interface 300 wherein the user may generate and manage communication protocols between the user and the real estate owner. The messaging interface 300 provides a message input wherein the user selects a message template or creates a new message template. The template allows the user to customize the communication between the user and the property owner. A message analysis interface 310 provides message analytics provided by the analytics engine to aid in the optimization of a campaign to convert leads into a purchase of the property. FIG. 4 illustrates a communication interface 500 permitting the user to select from a plurality of templates to generate a communication to the user. The communication interface may comprise a plurality of metrics including the number of communications transmitted, which utilize a particular template, to whom the template was delivered, delivery rates, response rates, etc. The messages interface provides a manual send feature which allows the user to select the send functionality to manually send one or more messages to a property owner. In some embodiments, each time the user selects the send feature, a single corresponding message is automatically transmitted to the property owner.

In some embodiments, the messaging interface provides one or more dynamic fields including names, contact information, and custom messages. In some embodiments, template messages may be stored in the database for future use. In some embodiments, template messages may be automatically rotated by the system to increase the likelihood of delivery.

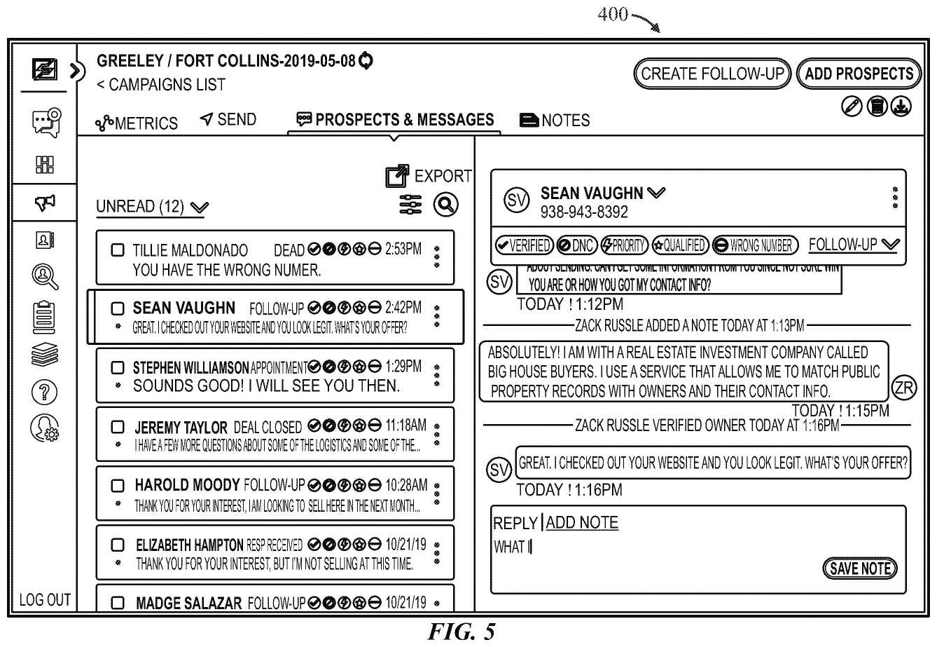

FIG. 5 illustrates a prospects and messages interface 400 configured to present the user with one or more prospects. As used herein, the term “prospect” is defined as a property owner (i.e., real estate owner) who may be interested in selling a property to the user. The prospect may have replied to a communication indicating that they have interest in selling the property to the user. Prospects may be automatically determined by the system or may be manually indicated by the user based on potential for a favorable outcome from the interaction. In some embodiments, a message interface permits the user to input a message and manually transmit the message to the property owner.

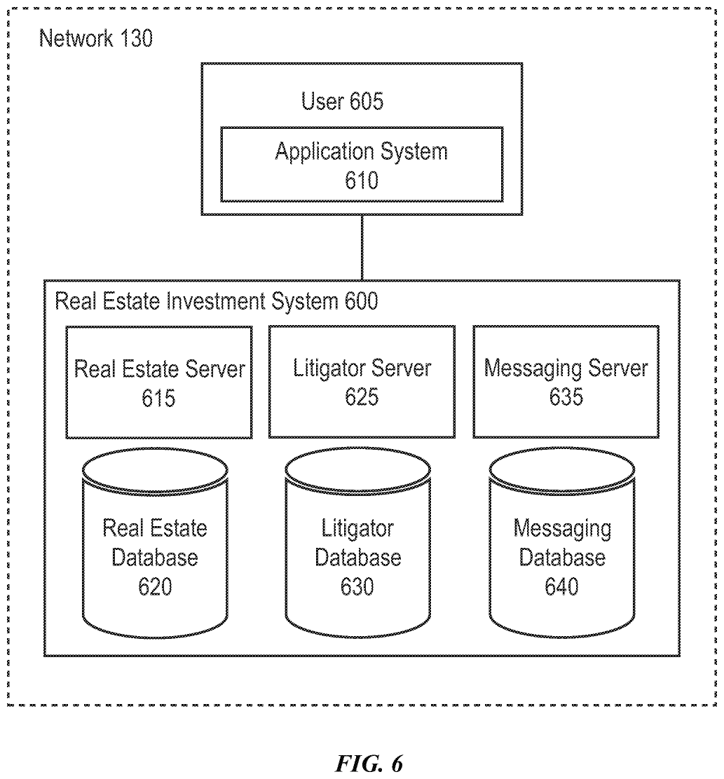

FIG. 6 illustrates a block diagram of the real estate investment system 600 operable by a user 605 utilizing an application system 610 configured to provide the various functionalities described hereinabove. The application system 610 is provided on a computing device, such as a desktop computer, laptop computer, smartphone, tablet, or other network-enabled device. The application system 610 is in operable communication with the real estate investment system 600 via the network 130. The real estate investment system 600 comprises a real estate server 615 in operable communication with a real estate database 620 configured to store real estate data for properties. The real estate server 615 transmits user-specified data to and from the real-estate database 620. A litigator server 625 is in operable communication with a litigator database 630 to transmit litigator data to the real estate investment system 600. A messaging server 635 transmits messaging data to and from a messaging database 640 configured to store message protocols, including user-specified messages which may be transmitted to the home owner. The application system 610 may automatically facilitate the processing and separation of favorable data from non-favorable data and further facilitate the transmission of processed and separated data between the communication module, real estate investment system, and real estate owner's device.

In some embodiments, the real estate database may be a third-party database comprising real estate data including property type, home owner data, estimated value, and similar real estate data known in the arts.

In some embodiments, the litigator database may be a third-party database in operable communication with a litigator identification service.

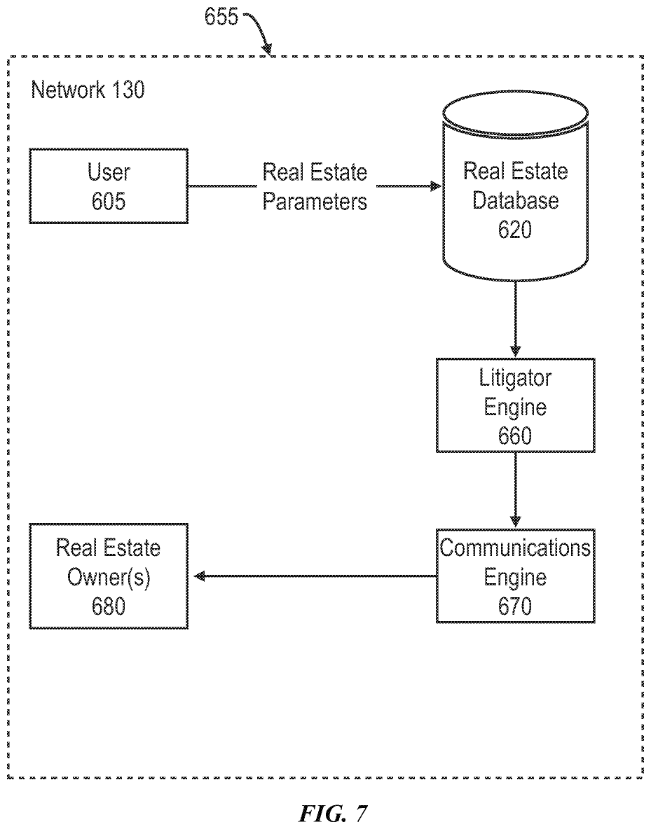

FIG. 7 illustrates a block diagram of the lead generation system 655 utilized by the user 605 to effectively communicate with real estate owners 680. The user 605 may input one or more real estate parameters or may use predetermined variable parameters for which they would like to query the real estate database. For example, the user 605 inputs that they are looking for houses within a ten-mile radius of the 90210 area code which have an estimated value between $1,000,000 and $1,500,000. Data for properties which correspond to the user's 605 inputs will be provided to the user 605. The data is transmitted from the real estate database 620 to the Skip Trace system 658 to enrich the prospect data, 660, which then systematically compares property owners with known litigators or others who may have a high risk of being a litigator, which are stored in the litigator database. The lead generation system 655 may systematically parse and separate high potential sales leads from low potential sales leads by comparing said multiple predetermined variable parameters to the real estate data in the real estate database 620 and the litigator data in the litigator database. The communications engine 670 may then generate a communication and manually transmit the communication to the real estate owner(s) 680 which the system has indicated to be a potential lead or leads.

In some embodiments, the Skip Trace system permits the system to scan through a database of properties which are selected based on user input real estate parameters or predetermined variable parameters and are transmitted to the litigator engine. The system may then systematically compare property owners with known litigators or others who may have a high risk of being a litigator, and process and separate high potential sales leads from low potential sales leads. A communications engine 670 may then generate a communication and transmit the communication to the real estate owner(s) 680 which the system has indicated to be a potential lead.

In some embodiments, the Skip Trace system is a third-party system which provides property and property owner information which is provided to the user.

FIG. 8 illustrates a lead management system 700 which may be utilized by real estate investors to procure, generate, and act on real estate leads. The system facilitates the process of identifying real estate owners in user-defined areas who have a user-defined property type. A comparator 710 is operable to systematically compare property data stored in a database with the user-defined or predetermined variable parameters to display only relevant properties to the user. The comparator 710 may be operable to compare property owners with a list of potential litigators to process, separate, or remove the litigators from the data provided to the user. In such, the lead management system 700 may protect against contacting property owners who are known litigators and thereby reducing low-quality leads and generating high-quality leads that have a higher likelihood of selling a property. An analytics engine 720 analyzes the transmission of communications sent and received by the communication module 730 and may optimally modify the communication type, frequency, and general communication strategy to increase the likelihood of converting a lead into a successful purchase of a property. The real estate selection module 740 may receive input from the user, including real estate parameters, litigator data, and other indicators to transmit high-value real estate data to the user. The high-value data is defined as data which has an increased likelihood to result in a purchase of the associated property. A parsing engine 750 may operate to systematically parse the real estate data into categories, which the user may use to selectively engage with. For example, data may be parsed by property type, estimated value, potential for litigation from the property owner(s), etc. A skip trace module 760 searches one or more databases storing property owner and property information.

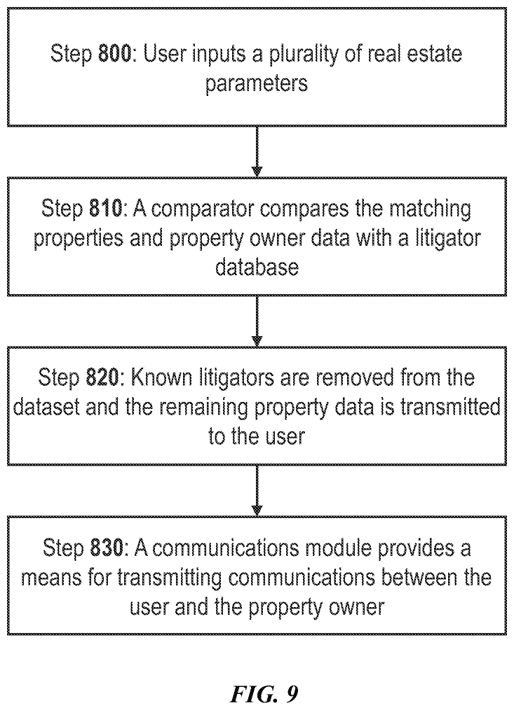

FIG. 9 illustrates a flowchart for a method of generating and managing leads for real estate investors provided by the embodiments described herein. In step 800, the user inputs, via a computing device, a plurality of real estate parameters and is provided with the search results from the real estate database and skip trace system. In some embodiments, the user may also upload from a database of their own. In step 810, a comparator systematically compares the properties and property owner data with a litigator database to identify any known litigators or persons indicated to be at a high-risk of litigation, who are then removed from the dataset in step 820. In step 830, a communications module provides a means for transmitting compliant communications between the user or the system and the property owner to inquire if the property owner is interested in selling the property. The communications module may be constructed and arranged to facilitate the transmission of communications between a real estate investment system and a real estate owner's device wherein the communication module, real estate investment system, and real estate owner's device are in operable communication with one another via the network. To communicate, human intervention is not necessarily required by the system prior to or during the communication between the system and the property owner.

In some embodiments, the user may add or remove property owners from a prospect list depending on the likelihood of a favorable outcome. For example, the user may remove a property owner from a prospect list if the property owner expresses no interest in selling their property.

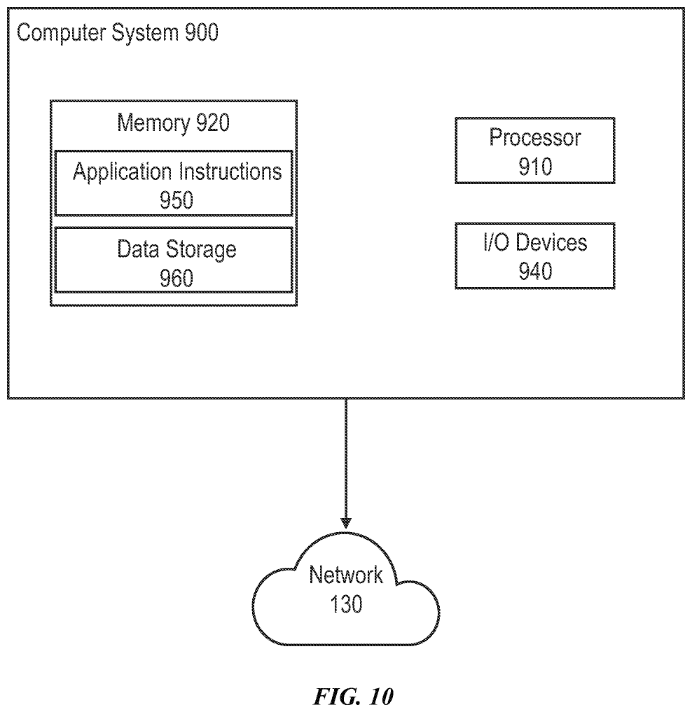

FIG. 10 illustrates a computer system 900, which may be utilized to execute the processes described herein. The computing system 900 is comprised of a standalone computer or mobile computing device, a mainframe computer system, a workstation, a network computer, a desktop computer, a laptop, mobile phone or the like. The computer system 900 includes one or more processors 910 coupled to a memory 920 via an input/output (I/O) interface. Computer system 900 may further include a network interface to communicate with the network 130. One or more input/output (I/O) devices 940, such as video device(s) (e.g., a camera), audio device(s), and display(s) are in operable communication with the computer system 900. In some embodiments, similar I/O devices 940 may be separate from computer system 900 and may interact with one or more nodes of the computer system 900 through a wired or wireless connection, such as over a network interface.

Processors 910 suitable for the execution of a computer program include both general and special purpose microprocessors and any one or more processors of any digital computing device. The processor 910 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 900 and other devices attached to a network 130, such as other computer systems, or between nodes of the computer system 900. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 920 may include application instructions 950, configured to implement certain embodiments described herein, and a database 960, comprising various data accessible by the application instructions 950. In one embodiment, the application instructions 950 may include software elements corresponding to one or more of the various embodiments described herein. For example, application instructions 950 may be implemented in various embodiments using any desired programming language, scripting language, or combination of programming languages and/or scripting languages (e.g., C, C++, C#, JAVA®, PYTHON, JAVASCRIPT®, PERL®, etc.).

The steps and actions of the computer system 900 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 910 such that the processor 910 can read information from, and write information to, the storage medium. In the alternative, the storage medium may be integrated into the processor 910. Further, in some embodiments, the processor 910 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

According to variation 1, a real estate investment management system may include a computing system including a computing device having one or more processors coupled to a memory for storing application instructions and data storage, an input/output (I/O) interface, and a network interface to communicate with the network. The system may further include a real estate database to store real estate data and transmit the real estate data to a real estate investment system via a real estate server; a litigator database to store litigator data and transmit the litigator data to the real estate investment system via a litigator server; a comparator to systematically compare the real estate data with the litigator data to determine if one or more potential litigators are present in a subset of the real estate data; a parsing engine to remove the one or more potential litigators from the subset of the real estate data; and a communications module constructed and arranged to facilitate the transmission of communications between a real estate investment system and a real estate owner's device wherein the communication module, real estate investment system, and real estate owner's device are in operable communication with one another via the network. The one or more processors systematically facilitate the processing and separation of favorable data from non-favorable data according to multiple predetermined variable parameters and by systematically comparing said multiple predetermined variable parameters to the real estate data and the litigator data to systematically process and separate high potential sales leads from low potential sales leads for the acquisition of property from potential sellers. The communications module may permit intervention by a user in the communication between the real estate investment system and the real estate owner via the input/output (I/O) interface and a network interface, to facilitate communication with property owner's devices.

Variation 2 may include a real estate investment management system as in variation 1 and may further include an analytics engine within a lead management system to analyze communications transmitted between the real estate investment system and the real estate owner to optimize a one or more campaigns to determine and communicate to a user favorable techniques for communicating with property owners in a particular area, at a particular estimated property value, or other real estate parameter.

Variation 3 may include a real estate investment management system as in any of variations 1 through 2 wherein the analytics engine analyzes the transmission of communications sent and received by the communication module, coupled with a parsing engine which is constructed and arranged to systematically parse data by property type, estimated value or potential for litigation from the property owner(s), modifies and transmits said favorable analytical data to a user dashboard interface to display the analytical data on a display of a computing device.

Variation 4 may include a real estate investment management system as in any of variations 1 through 3 wherein a messaging interface provides a plurality of templates to the user, wherein the user may select from the plurality of templates and apply the selected template to a campaign.

Variation 5 may include a real estate investment management system as in any of variations 1 through 4 wherein the analytics engine monitors the success rate of each of the plurality of templates.

Variation 6 may include a real estate investment management system as in any of variations 1 through 5 wherein the plurality of templates are stored in a messaging database in operable communication with the real estate investment system via a messaging server.

According to variation 7, a real estate investment management system may include computing system including: a computing device having one or more processors coupled to a memory for storing application instructions and data storage, an input/output (I/O) interface; a network interface to communicate with the network; a real estate database to store real estate data and transmit the real estate data to a real estate investment system via a real estate server; a litigator database to store litigator data and transmit the litigator data to the real estate investment system via a litigator server; a comparator to systematically compare the real estate data with the litigator data to determine if one or more potential litigators are present in a subset of the real estate data; a parsing engine to remove one or more real estate parameters or the one or more potential litigators from the subset of the real estate data; a communications module operable to transmit communications from the real estate investment system to a real estate owner's device, wherein the communications module permits intervention in the communication between the real estate investment system and the real estate owner's device via a user dashboard interface of a computing device. The dashboard interface may provide standard or configurable messaging templates with one or more dynamic data fields. The communications module may permit intervention in the communication between the real estate investment system and the real estate owner's device via the input/output (I/O) interface and a network interface, to facilitate communication with property owner's device to solicit the potential sale of the property.

Variation 8 may include a real estate investment management system as in variation 7 wherein the user selects the plurality of real estate parameters including at least one of a property address, a property owner name, or property last sold date.

Variation 9 may include a real estate investment management system as in any of variations 7 through 8 further including an analytics engine to analyze communications transmitted between the real estate investment system and the real estate owner's device to optimize a campaign.

Variation 10 may include a real estate investment management system as in any of variations 7 through 9 wherein the analytics engine transmits analytical data to a dashboard interface to display the analytical data on a display of a computing device.

Variation 11 may include a real estate investment management system as in any of variations 7 through 10 wherein a messaging interface provides a plurality of templates to a user, wherein the user may select from the plurality of templates and apply the selected template to a campaign.

Variation 12 may include a real estate investment management system as in any of variations 7 through 11 wherein the analytics engine monitors the success rate of each of the plurality of templates.

Variation 13 may include a real estate investment management system as in any of variations 7 through 12 wherein the plurality of templates are stored in a messaging database in operable communication with the real estate investment system via a messaging server.

According to variation 14, a method for managing real estate investment leads may include the steps of providing a computing system including: a computing device having one or more processors coupled to a memory for storing application instructions and data storage, an input/output (I/O) interface; a network interface to communicate with the network; storing, via a real estate database, real estate data and transmitting the real estate data to a real estate investment system via a real estate server; storing, via a litigator database, a plurality of litigator data and transmitting the litigator data to the real estate investment system via a litigator server; comparing, via a comparator, the real estate data with the litigator data and determining if one or more potential litigators are present in a subset of the real estate data; removing, via a parsing engine, the one or more potential litigators from the subset of the real estate data; and transmitting, via a communications module, communications from the real estate investment system to a real estate owner's device. The one or more processors may automatically facilitate the inclusion of favorable data and exclusion of non-favorable data according to multiple variable parameters input and by automatically comparing said multiple variable parameters to the real estate data and the plurality of litigator data to separate high potential sales leads from low potential sales leads for the acquisition of property from potential sellers prior to transmitting communications from the real estate investment system to a real estate owner's device. The communications module permits intervention by a user in the communication between the real estate investment system and the real estate owner's device via the input/output (I/O) interface and a network interface, to facilitate communication with a property owner's device to solicit the potential sale of the property.

Variation 15 may include a method for managing real estate investment leads as in variation 14 wherein the communications module permits intervention in the communication between the real estate investment system and the real estate owner via a user interface of a computing device.

Variation 16 may include a method for managing real estate investment leads as in any of variations 14 through 15 wherein a user selects a plurality of real estate parameters including at least one of a property address, a property owner name, or property last sold date.

Variation 17 may include a method for managing real estate investment leads as in any of variations 14 through 16 further including an analytics engine to analyze communications transmitted between the real estate investment system and the real estate owner's device to optimize a one or more campaigns to determine and communicate to a user favorable techniques for communicating with property owners in a particular area, at a particular estimated property value, or other real estate parameter in order to optimize a campaign to convert leads into a purchase of the property.

Variation 18 may include a method for managing real estate investment leads as in any of variations 14 through 17 wherein the user selects from a plurality of templates stored in a messaging database to optimize the success rate of a campaign.

Variation 19 may include a method for managing real estate investment leads as in any of variations 14 through 18 wherein the analytics engine monitors the success rate of each of the plurality of templates.

Variation 20 may include a method for managing real estate investment leads as in any of variations 14 through 19 wherein a real estate selection module permits the selection of the real estate data by automatically selecting one or more of the plurality of real estate parameters.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A real estate investment management system, comprising:
a computing system comprising: a computing device having one or more processors coupled to a memory for storing application instructions and data storage, an input/output (I/O) interface; a network interface to communicate with the network;
a real estate database to store real estate data and transmit the real estate data to a real estate investment system via a real estate server;
a litigator database to store litigator data and transmit the litigator data to the real estate investment system via a litigator server;
a comparator to systematically compare the real estate data with the litigator data to determine if one or more potential litigators are present in a subset of the real estate data;
a parsing engine to remove the one or more potential litigators from the subset of the real estate data; and
a communications module constructed and arranged to facilitate the transmission of communications between a real estate investment system and a real estate owner's device wherein the communication module, real estate investment system, and real estate owner's device are in operable communication with one another via the network;
wherein said one or more processors systematically facilitate the processing and separation of favorable data from non-favorable data according to multiple predetermined variable parameters and by systematically comparing said multiple predetermined variable parameters to the real estate data and the litigator data to systematically process and separate high potential sales leads from low potential sales leads for the acquisition of property from potential sellers; and
wherein the communications module permits intervention by a user in the communication between the real estate investment system and the real estate owner via the input/output (I/O) interface and a network interface, to facilitate communication with property owner's devices.

2. The system of claim 1, further comprising an analytics engine within a lead management system to analyze communications transmitted between the real estate investment system and the real estate owner to optimize a one or more campaigns to determine and communicate to a user favorable techniques for communicating with property owners in a particular area, at a particular estimated property value, or other real estate parameter.

3. The system of claim 2, wherein the analytics engine analyzes the transmission of communications sent and received by the communication module, coupled with a parsing engine which is constructed and arranged to systematically parse data by property type, estimated value or potential for litigation from the property owner(s), modifies and transmits said favorable analytical data to a user dashboard interface to display the analytical data on a display of a computing device.

4. The system of claim 1, wherein a messaging interface provides a plurality of templates to the user, wherein the user may select from the plurality of templates and apply the selected template to a campaign.

5. The system of claim 4, wherein the analytics engine monitors the success rate of each of the plurality of templates.

6. The system of claim 5, wherein the plurality of templates are stored in a messaging database in operable communication with the real estate investment system via a messaging server.

7. A real estate investment management system, comprising:
a computing system comprising: a computing device having one or more processors coupled to a memory for storing application instructions and data storage, an input/output (I/O) interface; a network interface to communicate with the network;
a real estate database to store real estate data and transmit the real estate data to a real estate investment system via a real estate server;
a litigator database to store litigator data and transmit the litigator data to the real estate investment system via a litigator server;
a comparator to compare the real estate data with the litigator data to determine if one or more potential litigators are present in a subset of the real estate data;
a parsing engine to remove one or more real estate parameters or the one or more potential litigators from the subset of the real estate data;
a communications module operable to transmit communications from the real estate investment system to a real estate owner's device, wherein the communications module permits intervention in the communication between the real estate investment system and the real estate owner's device via a user dashboard interface of a computing device;
wherein said dashboard interface provides standard or configurable messaging templates with one or more dynamic data fields; and
wherein the communications module permits intervention in the communication between the real estate investment system and the real estate owner's device via the input/output (I/O) interface and a network interface, to facilitate communication with property owner's device to solicit the potential sale of the property.

8. The system of claim 7, wherein the user selects the plurality of real estate parameters comprising at least one of a property address, a property owner name, or property last sold date.

9. The system of claim 8, further comprising an analytics engine to systematically analyze communications transmitted between the real estate investment system and the real estate owner's device to optimize a campaign.

10. The system of claim 9, wherein the analytics engine transmits analytical data to a dashboard interface to display the analytical data on a display of a computing device.

11. The system of claim 10, wherein a messaging interface provides a plurality of templates to a user, wherein the user may select from the plurality of templates and apply the selected template to a campaign.

12. The system of claim 11, wherein the analytics engine monitors the success rate of each of the plurality of templates.

13. The system of claim 12, wherein the plurality of templates are stored in a messaging database in operable communication with the real estate investment system via a messaging server.

14. A method for managing real estate investment leads, the method comprising the steps of:
providing a computing system comprising: a computing device having one or more processors coupled to a memory for storing application instructions and data storage, an input/output (I/O) interface; a network interface to communicate with the network;
storing, via a real estate database, real estate data and transmitting the real estate data to a real estate investment system via a real estate server;
storing, via a litigator database, a plurality of litigator data and transmitting the litigator data to the real estate investment system via a litigator server;
comparing, via a comparator, the real estate data with the litigator data and determining if one or more potential litigators are present in a subset of the real estate data;
removing, via a parsing engine, the one or more potential litigators from the subset of the real estate data;
transmitting, via a communications module, communications from the real estate investment system to a real estate owner's device;
wherein said one or more processors automatically facilitate the inclusion of favorable data and exclusion of non-favorable data according to multiple variable parameters input and by automatically comparing said multiple variable parameters to the real estate data and the plurality of litigator data to separate high potential sales leads from low potential sales leads for the acquisition of property from potential sellers prior to transmitting communications from the real estate investment system to a real estate owner's device, and
wherein the communications module permits intervention in the communication between the real estate investment system and the real estate owner's device via the input/output (I/O) interface and a network interface, to facilitate communication with a property owner's device to solicit the potential sale of the property.

15. The method of claim 14, wherein the communications module permits intervention in the communication between the real estate investment system and the real estate owner via a user interface of a computing device.

16. The method of claim 15, wherein a user selects a plurality of real estate parameters comprising at least one of a property address, a property owner name, or property last sold date.

17. The method of claim 16, further comprising an analytics engine to analyze communications transmitted between the real estate investment system and the real estate owner's device to optimize a one or more campaigns to determine and communicate to a user favorable techniques for communicating with property owners in a particular area, at a particular estimated property value, or other real estate parameter in order to optimize a campaign to convert leads into a purchase of the property.

18. The method of claim 17, wherein the user selects from a plurality of templates stored in a messaging database to optimize the success rate of a campaign.

19. The method of claim 18, wherein the analytics engine monitors the success rate of each of the plurality of templates.

20. The method of claim 19, wherein a real estate selection module permits the selection of the real estate data by automatically selecting one or more of the plurality of real estate parameters.
